(19) United States
(12) Patent Application Publication
(10) Pub. No.: US 2025/0341255 A1
(43) Pub. Date: Nov. 6, 2025

(54) BUFFER COMPONENT FOR ROOM TEMPERATURE VULCANIZING SEALANT

(71) Applicant: Steering Solutions IP Holding Corporation, Saginaw, MI (US)

(72) Inventor: Kevin M. McClendon, Saginaw, MI (US)

(21) Appl. No.: 19/073,697

(22) Filed: Mar. 7, 2025

Related U.S. Application Data
(60) Provisional application No. 63/641,099, filed on May 1, 2024.

(51) Int. Cl. F16J 15/02; G01M 3/28

(52) U.S. Cl. CPC F16J 15/02; G01M 3/2869

(57) ABSTRACT

A sealed joint assembly includes a plastic component. The sealed joint assembly also includes a metal component, wherein the plastic component and the metal component define a cavity in an assembled position. The sealed joint assembly further includes a room temperature vulcanized (RTV) material sealant disposed within the cavity. The sealed joint assembly yet further includes a buffer component disposed within the cavity, wherein the buffer component is in contact with the plastic component and the metal component.

### CROSS-REFERENCE TO RELATED APPLICATION

This application claims the benefits of priority to U.S. Provisional Patent Application Ser. No. 63/641,099, filed May 1, 2024, the disclosure of which is incorporated by reference herein in its entirety.

### FIELD OF THE INVENTION

The embodiments described herein relate to sealed assemblies and, more particularly, to a buffer component for room temperature vulcanizing sealed assemblies.

### BACKGROUND

Room temperature vulcanizing (RTV) material is utilized as an adhesive and sealant in various industries. While RTV material may provide a strong seal between two aluminum interfaces, as shown in FIG. 1, the sealant proves challenging when attempting to seal aluminum to plastic.

In an aluminum-to-plastic sealed assembly, RTV material will provide a robust seal once fully cured, but the drawback is the time required to achieve such curing. This can be particularly problematic in manufacturing and assembly processes which are sensitive to significant delays in any step of the process. For example, in the automotive industry, a pressurized leak test may be required to ensure that the seal adequately withstands a required pressure, as shown in FIG. 2. Passing the leak test may require waiting for hours after the RTV material is applied and a joint is assembled together. Even a non-cured RTV material sealed assembly may require hours to resist blowout during the leak test because a formed skin at gap locations required for manufacturing must be thick enough to resist the air pressure applied during the leak test. The assembly process is significantly slowed at a plant due to the need to wait for formation of the skins at the gap locations. The formation process can also be unpredictable.

### SUMMARY

According to one aspect of the disclosure, a sealed joint assembly includes a plastic component. The sealed joint assembly also includes a metal component, wherein the plastic component and the metal component define a cavity in an assembled position. The sealed joint assembly further includes a room temperature vulcanized (RTV) material sealant disposed within the cavity. The sealed joint assembly yet further includes a buffer component disposed within the cavity, wherein the buffer component is in contact with the plastic component and the metal component.

According to another aspect of the disclosure, a method of assembling and testing a sealed joint assembly having a cavity defined by a plastic component and a metal component is provided. The method includes securing a base portion of a buffer component to the plastic component, wherein a finger portion of the buffer component extends away from the base portion. The method also includes injecting a room temperature vulcanized (RTV) material sealant onto a plastic component surface. The method further includes assembling the metal component to the plastic component to define the cavity therebetween and to place the finger portion of the buffer component in contact with the metal component, wherein the buffer component and the RTV material sealant are disposed within the cavity. The method yet further includes applying a pressure with a fluid injected into the cavity to test the seal capability within the cavity.

These and other advantages and features will become more apparent from the following description taken in conjunction with the drawings.

### BRIEF DESCRIPTION OF THE DRAWINGS

The subject matter that is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a room temperature vulcanized (RTV) material sealing an aluminum component to another aluminum component.

FIG. 2 illustrates a RTV material sealing an aluminum component to a plastic component and being subjected to a pressurized leak test.

FIG. 3 is an elevation, cross-sectional view of a buffer for a RTV material sealing an aluminum component to a plastic component according to one aspect of the disclosure.

FIG. 4 is an elevation, cross-sectional view of a buffer for a RTV material sealing an aluminum component to a plastic component according to another aspect of the disclosure.

FIG. 5 is an elevation, cross-sectional view of a buffer for a RTV material sealing an aluminum component to a plastic component according to another aspect of the disclosure.

FIG. 6 is an elevation, cross-sectional view of a buffer for a RTV material according to another aspect of the disclosure and disposed within a recess defined by a plastic component prior to assembly of a joint between the plastic component and an aluminum component.

FIG. 7 is an elevation, cross-sectional view of the buffer of FIG. 6 subsequent to assembly of a joint between the plastic component and the aluminum component.

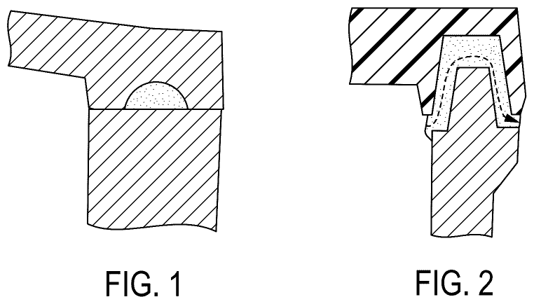

### DETAILED DESCRIPTION

The following discussion is directed to various embodiments of the disclosure. Although one or more of these embodiments may be described in more detail than others, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

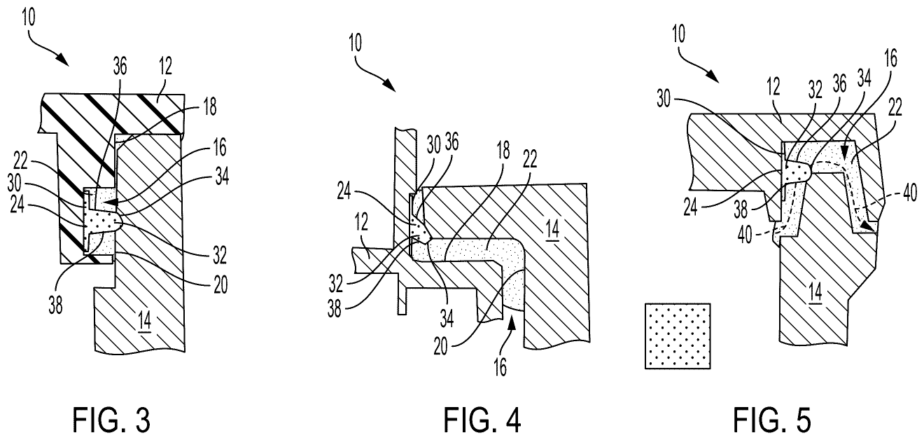

Referring to FIG. 3, a sealed joint assembly is shown and generally referenced with numeral 10. The sealed joint assembly 10 includes a first component 12 formed of plastic and a second component 14 formed of aluminum or another suitable metal. A cavity 16 is defined by surfaces of the plastic component and the metal component. In the illustrated embodiment, a plastic component surface 18 and a metal component surface 20 are shown in a particular orientation and with a specific segmentation to define a particular shape of the cavity 16. However, it is to be appreciated that the first component 12 (i.e., plastic component) and the second component 14 (i.e., metal component), as well as the contours and segmentation of the plastic component surface 18 and metal component surface 20, and the shape of the cavity 16, may vary from the example of FIG. 3. Other non-limiting examples are shown in FIGS. 4-7. The particular sealed joint application will determine the shapes and surface contours. It is to be understood that any joint with a cavity requiring sealing within a cavity defined by a plastic component and a metal component is within the scope of the disclosure.

A room temperature vulcanized (RTV) material sealant 22 is present within the cavity 16 to seal the components 12, 14 together. To avoid the need to wait extensive and unpredictable times for the RTV sealant 22 to cure to an extent adequate for pressurized leak testing, a buffer component 24 is disposed in the cavity 16.

The buffer component 24 remains within the cavity 16 during curing of the RTV sealant 22 and is a permanent part of the sealed joint assembly 10. The buffer component 24 may be formed in any suitable shape and will vary depending upon the geometric configuration of the components 12, 14 to be joined, including the cavity 16 size and geometry. In the example of FIG. 3, the buffer component 24 resides within a cavity 16 defined by a substantially C-shaped set of walls of the plastic component 12.

FIGS. 4 and 5 are examples of additional configurations of the cavity 16 and buffer component 24 shapes. It is to be appreciated that the buffer component 24 may be any suitable shape and may be utilized in any cavity 16 defined by a plastic component 12 and a metal component 14 to improve the resistance of the RTV sealant 22 for a pressurized leak test during the assembly process of the overall structure within which the sealed joint assembly 10 is disposed within. Therefore, the illustrated examples are not limiting of the scope of shapes and configurations which may benefit from the embodiments disclosed herein.

Regardless of the particular orientation of the sealed joint assembly 10, particularly the cavity 16, the buffer component 24 includes a base portion 30 which is substantially planar and in contact with a base wall defining the cavity 16. In the illustrated example, the base portion 30 of the buffer component 24 is in contact with, and fixed to, the plastic component 12. The buffer component 24 also includes a finger portion 32 extending from the base portion 30 of the buffer component 24 and into contact with a wall of the metal component 14. The finger component 32 may be in any suitable shape extending from the base portion 32. While the base portion 30 of the buffer component 24 is shown as being fixed to the plastic component 12 and the finger portion 32 being in contact with the metal component 14, it is to be appreciated that the reverse installation condition is present in some embodiments. In particular, the base portion 30 may be fixed to the metal component 14 and the finger component 32 may be in contact with the plastic component 12.

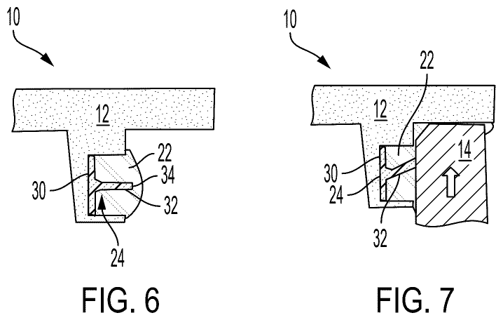

Referring to FIGS. 6 and 7, two stages of an assembly method are illustrated in connection with another embodiment of components 12, 14 and the cavity 16. In particular, FIG. 6 shows the plastic component 12 with RTV sealant 22 and the buffer component 24 disposed within the cavity 16. As shown, the finger portion 32 of the buffer component 24 extends away from the base portion 30 to a distal end 34 which is in contact with the metal component 14. FIG. 7 illustrates the metal component 14 being slid into a desired location to form the sealed joint assembly 10. During the sliding motion of the metal component 14 into the desired position, a portion of the finger portion 32 of the buffer component 24 is contacted by the metal component 14 and deflected, but due to the buffer component's resilient, durable material properties, the buffer component 24 remains in contact with the metal component 14 in the final assembled position.

The buffer component 24 may be formed of any suitable material to prevent the pressurized air from dislodging the RTV sealant 22 and to satisfy leak testing requirements that the cavity 16 is subjected to during an assembly process. For example, the buffer component 24 may be formed of a rubber material or any other durable material and pliable material, such as various thermoplastic elastomers (TPE) or a thermoplastic vulcanizate (TPV).

In any of the disclosed embodiments, all or a portion of the buffer component 24 may be in contact with the RTV sealant 22, or the buffer component 24 may be completely spaced from the RTV sealant 22. In particular, a portion of the buffer component 24 may be in contact with the RTV sealant 22, the finger portion 32 may be completely surrounded by the RTV sealant 22, or no portion of the buffer component 24 may be in contact with the RTV sealant 22. For example, the finger portion 32 of the buffer component 24 is surrounded by the RTV sealant 22 on a first side 36 and a second side 38 of the finger portion 32 in some embodiments. The finger portion 32 of the buffer component 24 is surrounded by the RTV sealant 22 only on the first side 36 of the finger portion 32 in other embodiments. The finger portion 32 of the buffer component 24 is spaced from the RTV sealant 22 within the cavity 16 in other embodiments.

As disclosed herein, the buffer component 24 may be in any shape or size suitable for various cavities. This variation includes different dimensions (e.g., width, thickness, etc.) of the base portion 30 and different configurations of the finger portion 32. The finger portion 32 may be a bulb-like structure with a rounded distal end 34, as shown in embodiments of FIGS. 3 and 5, or may have a more planar cross-section, as shown in FIGS. 6 and 7. However, it is to be appreciated that any shape or size of the finger portion 32 is contemplated. Additionally, the location of the finger portion 32 relative to the base portion 30, may vary from the centrally located position shown in FIGS. 3-7. Although a single finger portion 32 is shown in the illustrated embodiments, it is to be appreciated that multiple finger portions 32 may be formed with, and extend from, the base portion 30 in other embodiments. Finally, it is contemplated that multiple buffer components 24 may be located within a single cavity 16 in some embodiments.

The assembly process disclosed above is part of an overall assembly and testing process. In particular, the method includes securing the base portion 30 to the plastic component 12 and injecting the RTV sealant 22 along at least a portion of the plastic component surface 18 to adhere thereto. This may involve placing the RTV sealant 22 into contact with the finger portion 32 of the buffer component 24 in some embodiments, while the RTV sealant 22 is spaced from the finger portion 32 in other embodiments, as disclosed herein. With the buffer component 24 and the RTV sealant 22 in place, the metal component 14 and the plastic component 12 are positioned to be in an assembled position to define the cavity 16 therebetween. Assembling the metal component 14 to the plastic component 12 places the finger portion 32 of the buffer component 24 in contact with the metal component 14. This step may involve biasing the finger portion 32 away from an initial resting position to a deflected position, as shown well in FIGS. 4 and 7, for example. In this condition, a pressurized fluid 40 (FIG. 5), such as air for example, is injected into the cavity 16 to test the seal capability within the cavity 16.

The sealed joint assembly 10 and method disclosed herein may be utilized in any industry, but is particularly useful in a vehicle assembly process where plant delays are problematic. For example, the sealed joint assembly 10 may be used in any type of vehicle, such as a car, a truck, a sport utility vehicle, a mini-van, a crossover, any other passenger vehicle, any suitable commercial vehicle, or any other suitable vehicle. While the vehicle may be a passenger vehicle having wheels and for use on roads, the principles of the present disclosure may apply to other vehicles, such as planes, tractors, boats, or other suitable vehicles.

The embodiments disclosed herein beneficially eliminate the need for an O-ring seal, which is more costly than the use of the buffer component 24 and RTV sealant 22 due to elimination of housing machining & removal of the O-ring, while also avoiding the need for additional and unpredictable time needed for curing of the RTV sealant 22.

While the invention has been described in detail in connection with only a limited number of embodiments, it is to be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Moreover, any feature, element, component or advantage of any one embodiment can be used on any of the other embodiments. Accordingly, the invention is not to be seen as limited by the foregoing description.

What is claimed is:

1. A sealed joint assembly comprising:
a plastic component;
a metal component, wherein the plastic component and the metal component define a cavity in an assembled position;
a room temperature vulcanized (RTV) material sealant disposed within the cavity; and
a buffer component disposed within the cavity, wherein the buffer component is in contact with the plastic component and the metal component.

2. The sealed joint assembly of claim 1, wherein the buffer component comprises a base portion and a finger portion extending from the base portion.

3. The sealed joint assembly of claim 2, wherein the base portion is in contact with the plastic component and a distal end of the finger portion is in contact with the metal component.

4. The sealed joint assembly of claim 2, wherein the base portion has a planar shape.

5. The sealed joint assembly of claim 2, wherein the finger portion has rounded shape at a distal end thereof.

6. The sealed joint assembly of claim 2, wherein the finger portion has a flat shape at a distal end thereof.

7. The sealed joint assembly of claim 2, wherein the finger portion of the buffer component is surrounded by the RTV material sealant on a first side and a second side of the finger portion.

8. The sealed joint assembly of clam 2, wherein the finger portion of the buffer component is surrounded by the RTV material sealant on only a first side of the finger portion.

9. The sealed joint assembly of claim 2, wherein the finger portion of the buffer component is spaced from the RTV material sealant within the cavity.

10. The sealed joint assembly of claim 1, wherein the buffer component is formed of one of at least one of rubber, a thermoplastic elastomer, and a thermoplastic vulcanizate.

11. The sealed joint assembly of claim 1, wherein the metal component is formed of aluminum.

12. A method of assembling and testing a sealed joint assembly having a cavity defined by a plastic component and a metal component, the method comprising:
securing a base portion of a buffer component to the plastic component, wherein a finger portion of the buffer component extends away from the base portion;
injecting a room temperature vulcanized (RTV) material sealant onto a plastic component surface;
assembling the metal component to the plastic component to define the cavity therebetween and to place the finger portion of the buffer component in contact with the metal component, wherein the buffer component and the RTV material sealant are disposed within the cavity; and
applying a pressure with a fluid injected into the cavity to test the seal capability within the cavity.

13. The method of claim 12, wherein assembling the metal component to the plastic component comprises biasing the finger portion to a deflected position.

14. The method of claim 12, wherein injecting the RTV material sealant into the cavity comprises placing the RTV material sealant into contact with the finger portion of the buffer component.

15. The method of claim 12, wherein the fluid injected into the cavity to test the seal capability is pressurized air.
